(19) United States
(12) Patent Application Publication
(10) Pub. No.: US 2010/0169135 A1
(43) Pub. Date: Jul. 1, 2010

(54) SYSTEM AND METHOD FOR ASSET BILLING RECONCILIATION MANAGEMENT

(75) Inventors: Steven J. Lepari, Lebanon, NJ (US); John D. Adams, JR., Ft. Worth, TX (US); Marc Campos, Lockport, NY (US); Ralph C. Morrone, Sewell, NJ (US); John K. Fulton, Bryantville, MA (US)

Correspondence Address: VERIZON;PATENT MANAGEMENT GROUP, 1320 North Court House Road, 9th Floor, ARLINGTON, VA, 22201-2909, US

(73) Assignee: Verizon Patent and Licensing Inc., Basking Ridge, NJ (US)

(21) Appl. No.: 12/347,163

(22) Filed: Dec. 31, 2008

(51) Int. Cl. G06Q 10/00; G06F 17/30

(52) U.S. Cl. 705/7; 707/E17.048; 707/E17.005

(57) ABSTRACT

An approach is provided that includes assigning a unique identification to each individual of a plurality of individuals, compiling hierarchical data relating the individuals to each other, and collecting service data from one or more service providers relating to the plurality of individuals assigned with unique identifications, where the service data includes service charges associated with services provided to the plurality of individuals. Additionally, the hierarchical data and the service data are merged using the unique identifications to generate a table of service charges of the plurality of individuals in a hierarchical format.

### BACKGROUND INFORMATION

Modern businesses utilize a broad range of technologies to empower their employees to conduct business. For example, many companies provide employees with mobile telecommunication and computing devices that allow an employee to conduct business at many different locations. Companies may provide an employee with a cellular phone in order to contact customers or the company, and may provide an employee with a laptop computer that can wirelessly access the internet and the company's networks. Such devices can provide an employee with powerful tools to conduct business.

In order to provide an employee with such tools for conducting business, the company may need to utilize the services of various service providers, such as cellular telecommunication companies, internet access providers, etc. As a company increases in size and the number of devices/services being utilizes by employees of such a company increases, it can become difficult to compile and process the various services charges billed to a company. Also, it can become difficult for a company to assess usage by various employees and various departments within the company

Therefore, there is a need for an approach that provides for efficient collection and reconciliation of service charges to employees of a company as well as the summarization of those charges at each successive level of management.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of collecting and merging data to reconcile service charges for individuals in a hierarchical scheme, according to an exemplary embodiment;

FIG. 2 is a schematic diagram of an asset billing reconciliation management application, according to an exemplary embodiment;

FIG. 3 is a flowchart of a process for collecting and merging data and presenting the merged information, according to an exemplary embodiment;

FIG. 4 is a graphical user interface (GUI) configured to display the merged information associated with the process of FIG. 3, according to an exemplary embodiment; and

FIG. 5 is a diagram of a computer system that can be used to implement various exemplary embodiments.

### DESCRIPTION OF THE PREFERRED EMBODIMENT

A preferred apparatus, method, and system for collecting and merging data to reconcile service charges for individuals in a hierarchical scheme are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

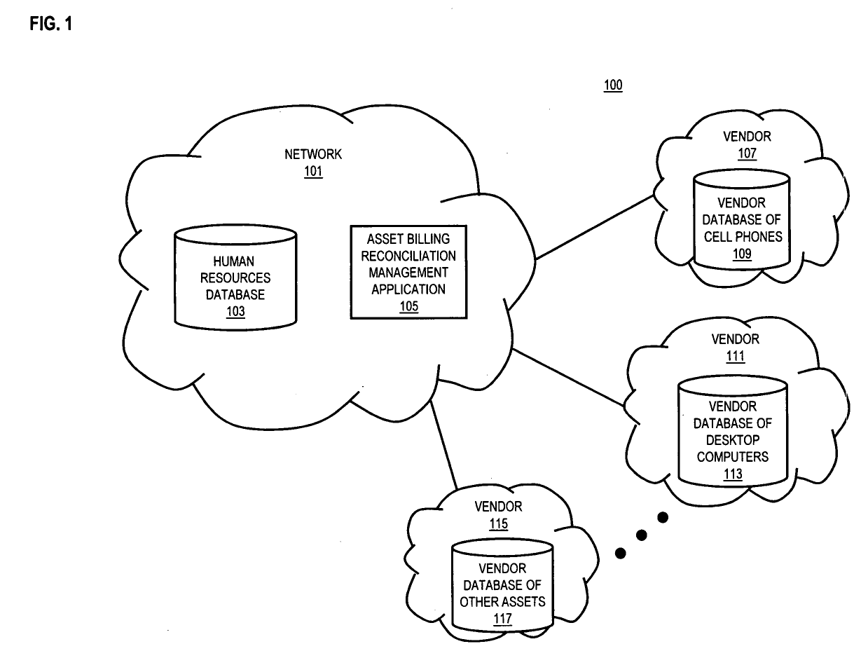

FIG. 1 is a diagram of a system 100 capable of collecting and merging data to reconcile service charges for individuals in a hierarchical scheme, according to an exemplary embodiment. In FIG. 1, a network 101 is depicted that represents a network of the companylbusiness/organization (generally referred to herein as “business” or “company”) that is utilizing the system for collecting and merging data to reconcile service charges for individuals (users) in a hierarchical scheme. The network 101 can be internal to the business or maintained/operated by a service provider. The network 101 includes or has access to a resources database (e.g., human resources) 103 and an application (or module) 105, which is referred to in FIG. 1 as an asset billing reconciliation management application.

The human resources database 103 contains a listing of all individuals (e.g., employees, volunteers, workers (generally referred to herein as “employee”)) of the organization or business, and can contain both past and present employees. The human resources database 103 also includes a listing of unique employee identifications (IDs) that can be manually or automatically generated and assigned to each employee of the business. This listing of employees, in an exemplary embodiment, also includes the unique employee identification of the individual's immediate supervisor.

The network 101 is connected to one or more vendors that provide certain services and/or assets. For example, vendor 107 can provide a vendor database 109 of cell phones, while vendor 111 includes a vendor database 113 of desktop computers. Vendor 115 can maintain a vendor database 117 of any type of asset. The network 101 can be wirelessly connected to the vendors' networks or connected via wired connections. Thus, the network 101 can receive billing, usage, or other service charge data attributable to the business and/or employees of the business. The various vendors can be any type of service provider that provides devices or services to the business and/or employees of the business. The vendors can send service charge statements to the network 101 on a periodic basis or as requested by the network 101.

Although the above system 100 is explained in the context of a business and employer/employee relationships, it is contemplated that the approach described herein, in certain embodiments, can be applied to any organization or community of users having any type of association and roles.

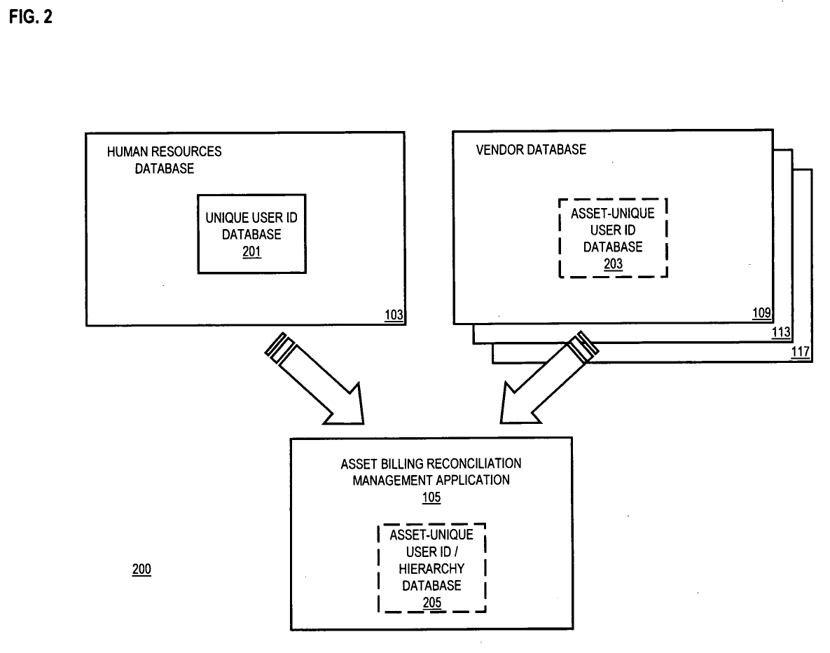

FIG. 2 is a schematic diagram of an asset billing reconciliation management application configured to collect and merge data from a human resources database 103 and one or more vendor databases, such as vendor databases 109, 113, and 117, according to an exemplary embodiment. The human resources database 103 contains a unique user (e.g. employee) ID database 201 that includes a listing of all employees of the business (e.g., both past and present employees), and includes a listing of unique employee identifications assigned to each employee. The human resources database 103 also contains a field identifying the employee's supervisor using the same unique employee identifier; e.g., this relationship can be specified using pointers. With a pointer data structure, the record of an employee would include the unique identifier of the supervisor, wherein this identifier corresponds to a record of the supervisor, whose record may further specify a unique identifier of the supervisor's manager, etc. This relationship can be implemented using the pointer data structure for records of all employees, and ultimately, the top manager would have a record with no indication of a supervisor identifier.

In an exemplary embodiment, the vendor databases 109, 113, and 117 contains an asset-unique user (e.g., employee) ID in database 203 that contains a listing of each asset/service provided by that vendor/service provider for the business with an associated unique employee ID for that asset/service. A particular employee ID may have one or more associated asset/service from one or more vendors. In an embodiment where the asset-unique employee ID database 203 is in the vendor database, the business would need to provide the vendor with the unique employee ID and associated asset/service information.

The asset billing reconciliation management application module 105 thus collects data from the human resources database 103 including the unique employee ID database 201 (also referred to as an “HR database”) and from the vendor databases 109, 113, and 117, etc., and merges the data to generate a table that reconciles service charges for individuals/employees in a hierarchical scheme 205 generated from the data found in database 201. The HR database 201 can be updated on a periodic basis or at any random time, for example, by the human resources personnel of the business in order to keep the hierarchical management structure of the business up to date. Also, the HR database 201 can include individuals that have retired, who are or are not included in the active hierarchy, in order to track and reconcile service charges attributable to such individuals.

The asset billing reconciliation management application module 105 allows vendor charges for company assets to be quickly and easily displayed at the employee level for which they are assigned, and summarize those charges at any reporting level above or below the employee. This simple representation of data allows organizations to quickly assess their current expenditures, examine allocation of assets through drill down menus of reporting structures and respond to any idiosyncrasies in the data through a simple interface for inquiry and resolution.

The system 200 allows a department or organization to pull all of the data regarding invoices of assets and services that its employees use in their daily activities together in a coherent and substantive manner. Moreover, the system 200 has the capability of reporting on breakdowns of specific types of assets. The system 100 also permits departments/businesses to view the volume of devices owned/used by their employees and the granularity of their departmental spending, thus allowing these organizations to prevent overspending on resources they need to conduct business. Such arrangement provides a simple way to view the total spending at a high level with the ability to then breakdown those expenditures down to the cost causers.

Furthermore, the system 200 provides a means of deriving, from a human resources (HR) database, an employee record that shows some data about the employee and the chain-of-command for each successive boss. The system 200 couples that information with vendor data that can be linked to the HR chain of command via the employee assigned to the vendor provided asset.

According to certain embodiments, the system 200 provides two separate operations that provide distinct functionality to the end-users. The first operation of the system and method combines and creates data from an HR feed from an HR database, and a vendor feed from one or more vendor databases of monthly charges for devices. The second operation pertains to the presentation of data, as next explained.

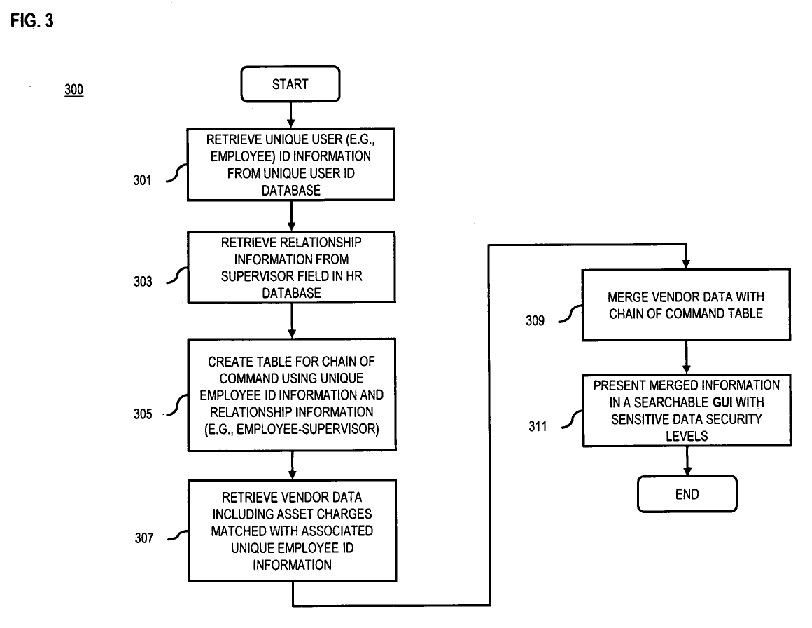

FIG. 3 is a flowchart of a process 300 for collecting and merging data to reconcile service charges for individuals in a hierarchical scheme, and presenting the merged information in a searchable spreadsheet, according to an exemplary embodiment.

The process 300 begins, as in step 301, with the retrieving of unique user (e.g., employee) ID information from the unique user ID database 201 for all of the employees along with the unique employee identifier of the supervisor. According to one embodiment, relationship information is inherently provided from the supervisor field in the HR database 201 for each entry (step 303). In step 305, a table is created for the chain of command using the unique employee information and the employee-supervisor information. Thus, for example, on the first day of each month, using an HR feed that provides a unique identifier for the employee and a unique identifier for the employee's boss, a table is created utilizing a recursive program to determine the complete chain of command for that employee up through the head of the company. This can be performed for each employee each month so that the organizational structure is captured for the month. This table of data can then be inverted so that each employee's hierarchy begins with the head of the company and has the command structure down to the employee. The table can also contain other information about the employee and the chain of command, such as whatever HR data is pertinent to the desired presentation of information. Information such as name and title for each person, as well as their manager's name and title, can help to clarify organization. This chain-of-command field advantageously allows later data to be summarized at each hierarchical level.

In step 307, the vendor data is retrieved including asset/service charges, which are matched, either at the vendor or at the business network, with the associated unique employee ID information. Then, in step 309, the vendor data is merged with the chain of command table; and the merged information is presented within a graphical user interface (GUI) as a searchable table/spreadsheet with sensitive data security levels in step 311. Thus, for example, once the chain of command table is completed, it is merged with vendor data as it arrives over the course of the month. The vendor data will have the devices and monthly charges for all assets that are invoiced to the company. The vendor data can also include the unique identifier on each record of the employee responsible for the device, if such information is provided to the vendor, or the vendor data can include a unique identifier for each record that is generated by the vendor and the company's databases can correlate this vendor-provided identifier with a unique employee ID.

The data can also be enhanced with other vendor's feeds of devices or services. For example, fields indentifying the asset and the unique identifier of the employee are provided. The vendor's data can also be enhanced by feeds that provide more information about the vendor's asset. For instance, a feed from accounts payable providing payment data on the asset can be used to further clarify the full circle of charge and payment. The process matches the unique identifier with the asset.

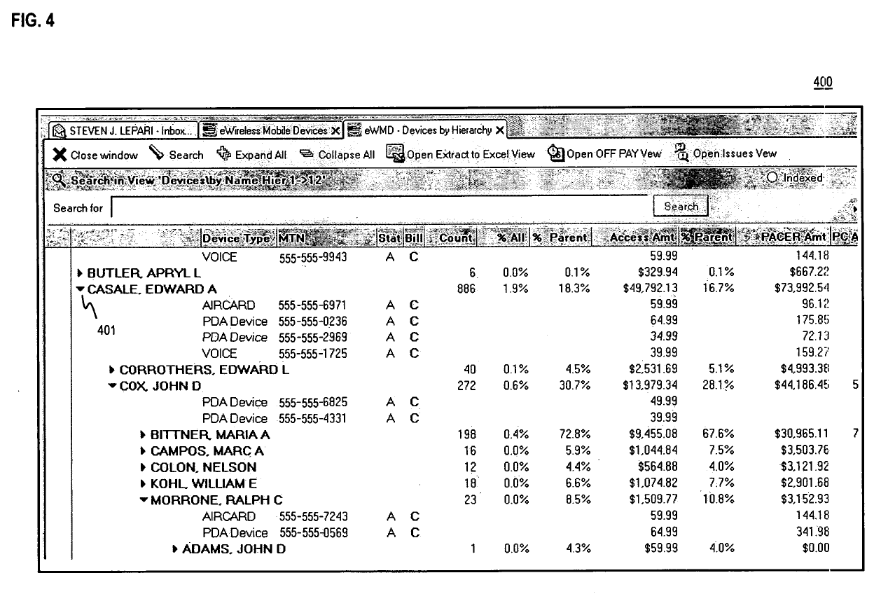

Once the data is loaded, the end-users can access the information. In an exemplary implementation, as shown in FIG. 4, a web-based front-end is utilized. This front-end provides built-in capabilities that simplify the presentation, summary of data and drill-down functionality. Also, security can be maintained, for example, using email address password protection.

FIG. 4 is a graphical user interface (GUI) configured to display the merged information associated with the process of FIG. 3, according to an exemplary embodiment. Specifically, a screenshot 400 provides a spreadsheet-like display of merged information. In this display, users can easily see total charges for a particular person, including an indented rollup of all the people that report to that person. To view a breakdown of cost causers, a user can simply “drill down” by clicking on a “twistee” 401 (i.e. the rotatable triangle to the left of the person's name) for people under the person in question. This presentation provides an intuitive interface to quickly see where money is being spent in an organization and to compare types of devices and associated costs, dissimilar service plans, multiple devices assigned to an individual, etc.

As the charges roll all of the way up to the head of the company and reveal sensitive information, security may need to be implemented to limit access to potentially restricted data. A simple implementation is to only allow users to see their devices and those of the people below them. Special access is granted to specific people who are responsible for managing the inventory for large organizations.

The front-end provides all of the functional components of the application. Users can search the database for specific devices based on the device identifier, or use pre-configured views that break data down by device types. The users can select data and extract it to a spreadsheet for their own purposes or click on a device and tag it for disconnection, ownership changes and/or feature/rate plan changes. For example, a notification (e.g., an email) can be sent to the centralized group that manages the vendor and pays the invoices. This can then be followed up the next month to see if the device has been disconnected and charges terminated. The front-end can be bill period specific so that end-users can compare their expenditures month-by-month, for example.

There can also be administrative functionality for the team that manages the corporate accounts. For example, the team can pull exceptions reports of assets that do not match up to any employee (e.g., possible items that are miss-billed to the corporate accounts) and assets assigned to retirees or people off of the payroll that were never disconnected. Also, tracking reports for the requests that end-users submitted (see above paragraph) so that administrators can follow up on end-user requests. In an exemplary embodiment, an interface can be provided to the vendor so that the requested end-user changes are mechanically changed at the vendor's site and confirmation sent back to the application.

The described arrangement provides a way to consolidate disparate billed assets and services with accounts payable data into a single portal that can view total expenditures at any level with a simple drill down. Combined with the ability to then take action and direct inquiries and instructions on assets to the teams responsible for resolution, this approach provides significant advantages in asset management.

The system 100 can be used to manage virtually any billable invoice where the charges can be allocated to an understood asset and that asset assigned to an employee.

The processes described herein may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

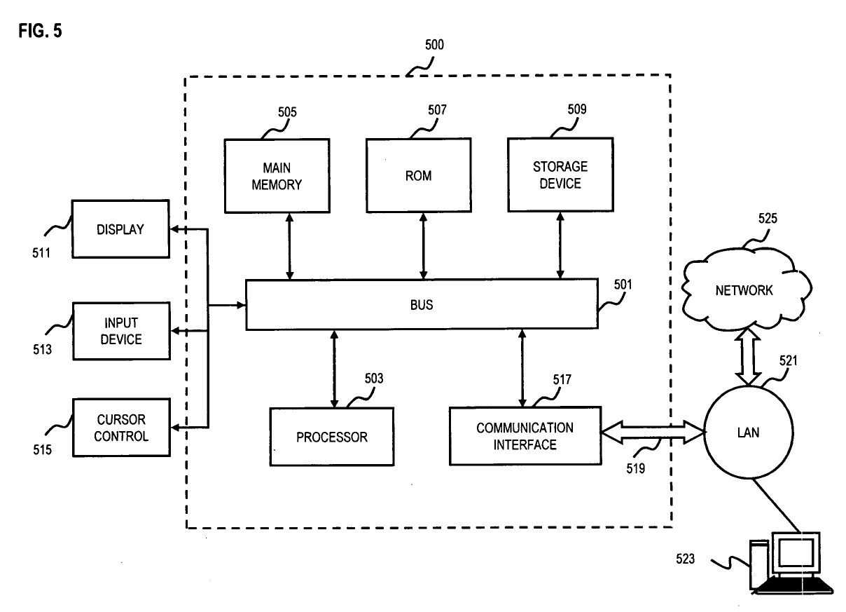

FIG. 5 illustrates computing hardware (e.g., computer system) upon which an embodiment according to the invention can be implemented. The computer system 500 includes a bus 501 or other communication mechanism for communicating information and a processor 503 coupled to the bus 501 for processing information. The computer system 500 also includes main memory 505, such as random access memory (RAM) or other dynamic storage device, coupled to the bus 501 for storing information and instructions to be executed by the processor 503. Main memory 505 also can be used for storing temporary variables or other intermediate information during execution of instructions by the processor 503. The computer system 500 may further include a read only memory (ROM) 507 or other static storage device coupled to the bus 501 for storing static information and instructions for the processor 503. A storage device 509, such as a magnetic disk or optical disk, is coupled to the bus 501 for persistently storing information and instructions.

The computer system 500 may be coupled via the bus 501 to a display 511, such as a cathode ray tube (CRT), liquid crystal display, active matrix display, or plasma display, for displaying information to a computer user. An input device 513, such as a keyboard including alphanumeric and other keys, is coupled to the bus 501 for communicating information and command selections to the processor 503. Another type of user input device is a cursor control 515, such as a mouse, a trackball, or cursor direction keys, for communicating direction information and command selections to the processor 503 and for controlling cursor movement on the display 511.

According to an embodiment of the invention, the processes described herein are performed by the computer system 500, in response to the processor 503 executing an arrangement of instructions contained in main memory 505. Such instructions can be read into main memory 505 from another computer-readable medium, such as the storage device 509. Execution of the arrangement of instructions contained in main memory 505 causes the processor 503 to perform the process steps described herein. One or more processors in a multi-processing arrangement may also be employed to execute the instructions contained in main memory 505. In alternative embodiments, hard-wired circuitry may be used in place of or in combination with software instructions to implement the embodiment of the invention. Thus, embodiments of the invention are not limited to any specific combination of hardware circuitry and software.

The computer system 500 also includes a communication interface 517 coupled to bus 501. The communication interface 517 provides a two-way data communication coupling to a network link 519 connected to a local network 521. For example, the communication interface 517 may be a digital subscriber line (DSL) card or modem, an integrated services digital network (ISDN) card, a cable modem, a telephone modem, or any other communication interface to provide a data communication connection to a corresponding type of communication line. As another example, communication interface 517 may be a local area network (LAN) card (e.g. for Ethernet™ or an Asynchronous Transfer Model (ATM) network) to provide a data communication connection to a compatible LAN. Wireless links can also be implemented. In any such implementation, communication interface 517 sends and receives electrical, electromagnetic, or optical signals that carry digital data streams representing various types of information. Further, the communication interface 517 can include peripheral interface devices, such as a Universal Serial Bus (USB) interface, a PCMCIA (Personal Computer Memory Card International Association) interface, etc. Although a single communication interface 517 is depicted in FIG. 5, multiple communication interfaces can also be employed.

The network link 519 typically provides data communication through one or more networks to other data devices. For example, the network link 519 may provide a connection through local network 521 to a host computer 523, which has connectivity to a network 525 (e.g. a wide area network (WAN) or the global packet data communication network now commonly referred to as the “Internet”) or to data equipment operated by a service provider. The local network 521 and the network 525 both use electrical, electromagnetic, or optical signals to convey information and instructions. The signals through the various networks and the signals on the network link 519 and through the communication interface 517, which communicate digital data with the computer system 500, are exemplary forms of carrier waves bearing the information and instructions.

The computer system 500 can send messages and receive data, including program code, through the network(s), the network link 519, and the communication interface 517. In the Internet example, a server (not shown) might transmit requested code belonging to an application program for implementing an embodiment of the invention through the network 525, the local network 521 and the communication interface 517. The processor 503 may execute the transmitted code while being received and/or store the code in the storage device 509, or other non-volatile storage for later execution. In this manner, the computer system 500 may obtain application code in the form of a carrier wave.

The term “computer-readable medium” as used herein refers to any medium that participates in providing instructions to the processor 503 for execution. Such a medium may take many forms, including but not limited to non-volatile media, volatile media, and transmission media. Non-volatile media include, for example, optical or magnetic disks, such as the storage device 509. Volatile media include dynamic memory, such as main memory 505. Transmission media include coaxial cables, copper wire and fiber optics, including the wires that comprise the bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A computer-implemented method comprising:
assigning a unique identification to each individual of a plurality of individuals;
compiling hierarchical data relating the individuals to each other;
collecting service data from one or more service providers corresponding to the plurality of individuals, wherein the service data includes service charges associated with services provided to the plurality of individuals; and
merging the hierarchical data and the service data using the unique identifications to generate a table of service charges of the plurality of individuals in a hierarchical format.

2. The method of claim 1, wherein the table includes a listing of individuals subordinate to each respective individual of the plurality of individuals and service charges associated with the subordinate individuals.

3. The method of claim 2, wherein the table includes percentages of charges for each subordinate individual as such charges relate to overall charges of all subordinate individuals under the respective individual.

4. The method of claim 1, further comprising providing the one or more service providers with the unique identifications, wherein the service data collected from the one or more service providers includes the unique identifications associated with the service charges.

5. The method of claim 1, wherein the service data from the one or more providers includes a service-provider-assigned identification associated with the service provided, and further comprising matching the service-provider-assigned identification in the service data with the unique identification.

6. The method of claim 1, wherein the service data includes charges related to an asset and/or service used by the individual.

7. The method of claim 1, wherein at least one unique identification is associated with a plurality of service charges from the one or more service providers.

8. The method of claim 7, wherein each of the plurality of service charges relates to a respective asset and/or service used by the individual associated with the respective unique identification.

9. The method of claim 1, further comprising identifying any service data that does not correspond to a unique identification.

10. The method of claim 1, wherein the compiled hierarchical data relates the individuals to each other using the unique identifications according to a pointer data structure.

11. A system comprising:
a unique identification database configured to store a unique identification assigned to each individual of a plurality of individuals;
a hierarchical database configured to store hierarchical data relating the individuals to each other; and
a module configured to collect service data from one or more service providers corresponding to the plurality of individuals, wherein the service data includes service charges associated with services provided to the plurality of individuals, and wherein said module is configured to merge the hierarchical data and the service data using the unique identifications to generate a table of service charges of the plurality of individuals in a hierarchical format.

12. The system of claim 11, wherein said module is configured to generate the table to include a listing of individuals subordinate to each individual of the plurality of individuals and service charges associated with the subordinate individuals.

13. The system of claim 12, wherein said module is configured to generate the table to include percentages of charges for each subordinate individual as such charges relate to overall charges of all subordinate individuals under the respective individual.

14. The system of claim 11, wherein the service data collected from the one or more service providers includes the unique identifications associated with the service charges.

15. The system of claim 11, wherein the service data from the one or more providers includes a service-provider-assigned identification associated with the service provided, and wherein said module is configured to match the service-provider-assigned identification in the service data with the unique identification.

16. The system of claim 11, wherein the service data includes charges related to an asset and/or service used by the individual.

17. The system of claim 11, wherein at least one unique identification is associated with a plurality of service charges from the one or more service providers.

18. The system of claim 17, wherein each of the plurality of service charges relates to a respective asset and/or service used by the individual associated with the respective unique identification.

19. The system of claim 11, wherein said module is configured to identify any service data that does not correspond to a unique identification.

20. The system of claim 11, wherein the compiled hierarchical data relates the individuals to each other using the unique identifications according to a pointer data structure.
